(19) United States
(12) Patent Application Publication
(10) Pub. No.: US 2014/0289044 A1
(43) Pub. Date: Sep. 25, 2014

(54) METHOD AND SYSTEM FOR DELIVERING CURSOR-BASED CONTENTBASED ON USER INPUTS

(71) Applicants: Craig Pisaris-Henderson, Ft. Myers, FL (US); Christopher David Edge, Ft. Myers, FL (US)

(72) Inventors: Craig Pisaris-Henderson, Ft. Myers, FL (US); Christopher David Edge, Ft. Myers, FL (US)

(73) Assignee: Lexos Media IP, LLC, Palo Alto, CA (US)

(21) Appl. No.: 14/215,524

(22) Filed: Mar. 17, 2014

Related U.S. Application Data
(60) Provisional application No. 61/789,882, filed on Mar. 15, 2013.
(60) Provisional application No. 61/821,935, filed on May 10, 2013.

(51) Int. Cl. G06Q 30/02

(52) U.S. Cl. CPC G06Q 30/0256; G06Q 30/0277
USPC 705/14.54; 705/14.73

(57) ABSTRACT

A client side computer system for receiving and displaying advertising content in a computer network includes a user input device, a display device, a keyword capture module extracting keyword data from user input, an ad invocation module, and an ad deployment module. The ad invocation module is responsive to the keyword capture module and generates an advertising call request to an advertising server. The ad deployment module receives an advertisement from the advertising server and displays the advertisement on a requested webpage displayed on the display device.

### FIELD OF THE INVENTION

The present invention relates generally to the delivery of content over a telecommunication network, and more particularly relates to the delivery and display of content, such as advertising content.

### BACKGROUND

Advertising has been, and continues to be, a leading business opportunity on the Internet. The Internet, being an interactive media, offers significant advantages over traditional media in offering dynamic methods of targeting advertisements to certain audiences, publishing customizable advertisements to certain audiences and tracking the effectiveness of an advertisement by evaluating audience reaction to an advertisement.

One mechanism for internet advertising, introduced by Comet Systems, Inc. in 1999, used the image space on a user's computer generally associated with the user's cursor to deliver an advertisement. For example, Comet Systems introduced the use of a dynamic cursor image to provide a “branded” cursor that would correspond to the content or sponsor of the web page being visited. The Comet Cursor system is described, for example, in U.S. Pat. Nos. 5,995,102, 6,118,449, 6,065,057, and 7,111,254, which are hereby incorporated by reference in their entireties.

A user's cursor is an important display space since it generally represents the users point of focus on a particular page being displayed. Nonetheless, although Comet System, Inc.'s “comet cursor” enjoyed initial popularity, the use of cursor-based advertising has not found widespread acceptance. It is believed that improvements to the features, delivery and operation of a cursor-based content delivery system can result in the highly effective use of the cursor space as a component of a powerful advertising delivery system.

### BRIEF DESCRIPTION OF THE DRAWINGS

Embodiments of the present systems and methods are described in connection with the appended drawings, in which:

FIG. 1 is a block diagram illustrating the interaction among various operational entities in the present advertising delivery and analysis system;

FIG. 2 is an example of an internet webpage displayed on a client computer when reviewing content provided at a website presented by a publisher server;

FIGS. 3-5 are examples of web pages illustrating the use of the present cursor-based advertising system to display a cursor-based advertisement and additional promotional material related thereto;

FIG. 6 is an example of additional promotional material deliverable using the present system and methods;

FIG. 7 is a flow chart illustrating the operation of an example of a publisher server, in accordance with the current disclosure;

FIG. 8 is a flow chart illustrating the operation of an example of an advertising server, in accordance with the current disclosure; and

FIG. 9 is a pictorial representation of a configurable “container” for delivering and displaying cursor-based content in accordance with the current disclosure.

FIG. 10A is a block diagram illustrating the interaction among various operational entities in the present advertising delivery and analysis system and a client side software application installed on a client computer.

FIG. 10B-C are block diagram illustrating various embodiments of the interaction among various operational entities in the present advertising delivery and analysis system and a client side software application installed on a client computer.

FIG. 11 is a flow chart illustrating the method of identification of appropriate advertisement from multiple advertisements, retrieved by an advertising server.

FIG. 12A is an example of a web page illustrating the feature of displaying of cursor advertisement in relation to a banner advertisement.

FIG. 12B is an example of a web page illustrating the feature of detachable cursor advertisement.

FIG. 12C is an example of a web page illustrating the movement of a cursor advertisement from the cursor image to the banner advertisement.

### DETAILED DESCRIPTION

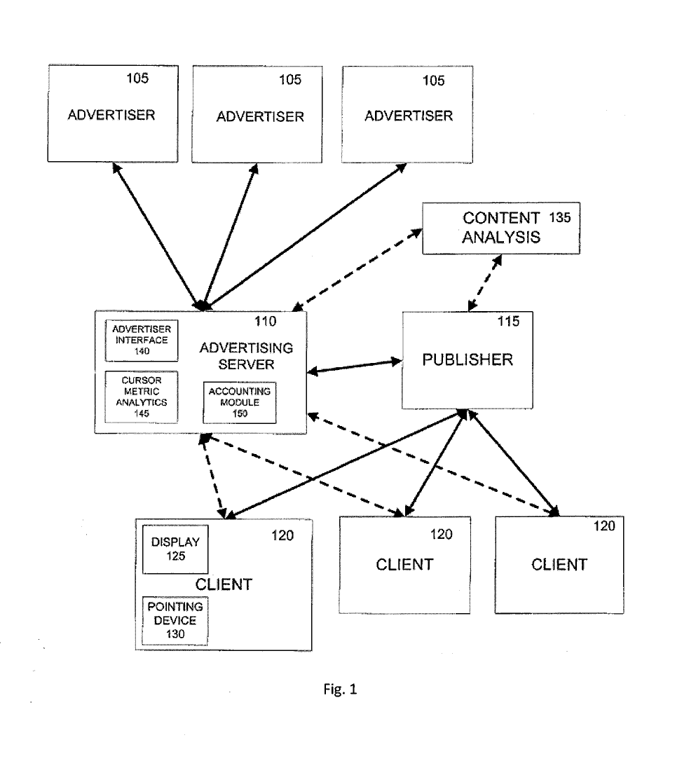

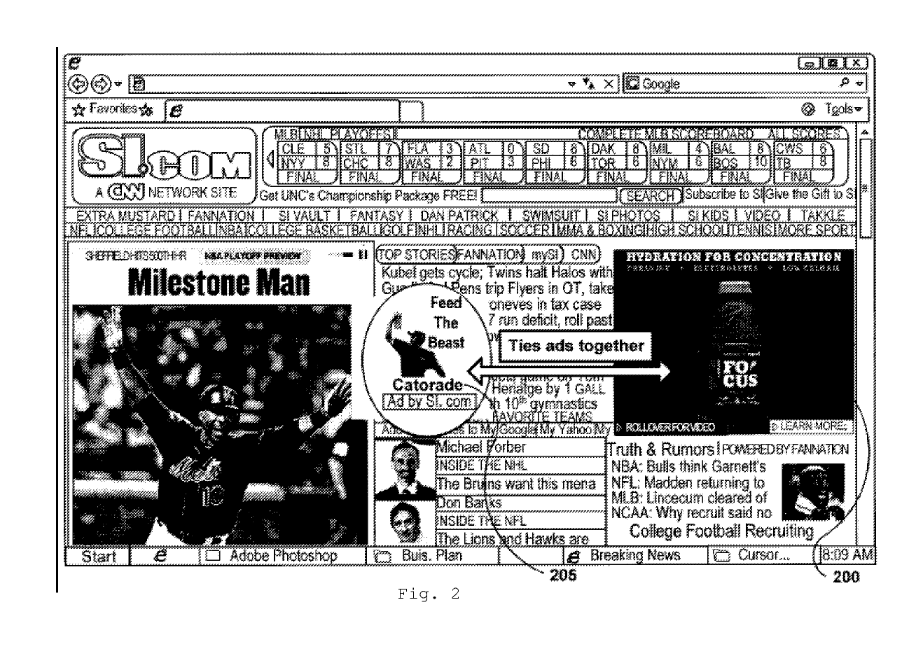

FIG. 1 is a block diagram illustrating the interaction among various operational entities in the present advertising delivery and analysis system. The present system generally provides an advertising server 110 which includes an interface to one or more advertiser computers 105. The advertising server 110 provides an account management interface 140 that allows a user of an advertiser computer to define an advertisement, define campaign parameters, review advertising metrics and the like. Typically, the account management interface includes a secure login to allow individual account owners to access and manipulate only their own accounts. The advertising server 110 also provides an interface to one or more publisher servers 115. The publisher servers 115 generally provide content to users on a computer network, such as the Internet. The publisher servers 115 also receive advertising content from the advertising server 110 for presentation to one or more client computers 120.

The client computers 120, which may include any of a number of standard computing devices such as PC, laptop, PDA, cell phone, tablet computer and the like, can be coupled to a publisher server via a computer network, such as the internet, using known wired or wireless networking techniques. The client computers generally include a graphical user interface (GUI), including a display device 125 and a pointing device 130, such as a mouse, track ball, touch sensitive pad, touch screen and other known human interface devices. As is well known in the art, the GUI generally provides a cursor illustrating a visual position indication on the display device 125 and the position of the cursor can be controlled by the pointing device 130. In certain devices, a touch screen may be used to implement a GUI. With a touch screen interface, a cursor may not need to be displayed since the user can select any spot on the interface as a touchpoint. In such an embodiment, the present cursor based systems and methods can be applied using the touchpoint as the location to display the cursor-based content or advertisement.

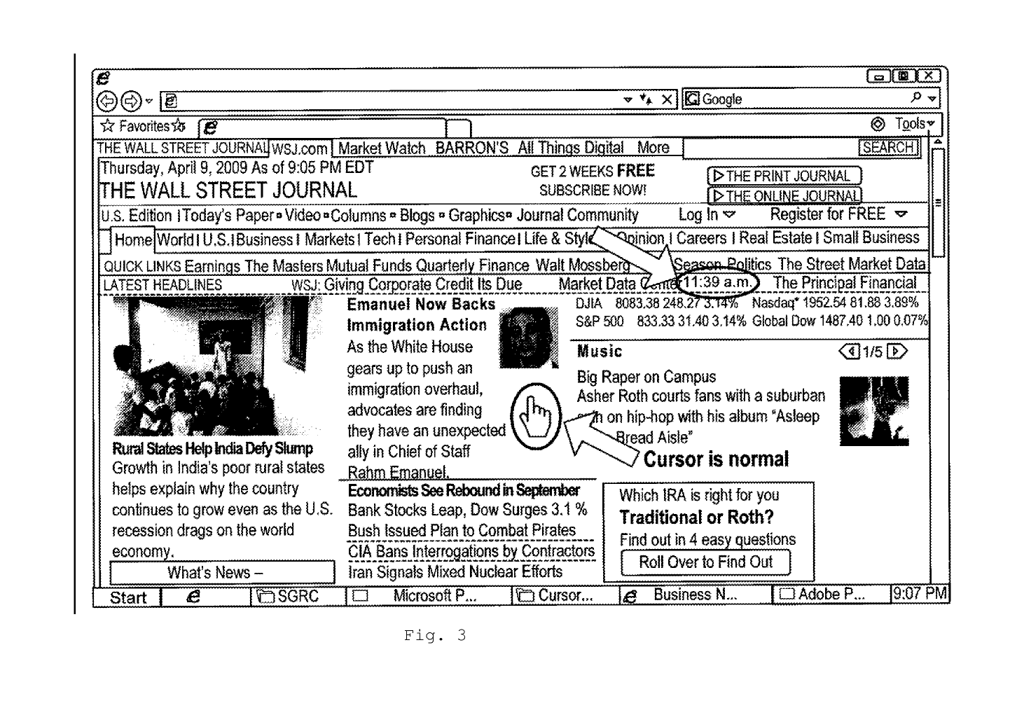

FIG. 2 is an example of an internet webpage displayed on client computer 120 when reviewing content provided by a publisher server 115. In this example, the user of the client computer 120 is visiting a website that is focused on sports related issues. In this example, the manufacturer of a sports drink has defined an advertising campaign in the advertising server 110 that includes a traditional display or banner advertisement 200 as well as an associated cursor-based advertisement 205 that are presented to the client computer. As used herein, the term “cursor-based content” includes content, such as advertising and other image and message content, that is displayed either instead of, attached to, associated with or in conjunction with a conventional cursor image, including being displayed under, over, relative to or next to a conventional cursor image. In this case, the cursor based advertisement 205 presents an image and or text message that relates to and preferably compliments the traditional display advertisement 200. It has been found that the combination of a display advertisement with a cursor-based advertisement significantly increases advertising awareness and effectiveness when compared to using a display ad without the associated cursor-based advertisement.

In this example, the cursor-based advertisement can be presented simultaneously with the display advertisement. In order to minimize user distraction and potential annoyance, the cursor can revert to the standard cursor image after a predetermined time. For example, after five seconds, the cursor-based advertisement can fade back into a standard arrow. The cursor-based advertisement can also be displayed or removed based on some user activity. For example, if the cursor is moved over the display advertisement 200, the cursor-based advertisement image can be re-displayed (or an additional cursor-based advertisement can be displayed). Alternatively, if the user engages in some action, such as a click of a particular mouse button or performing a predetermined cursor movement, the cursor-based advertisement can be immediately replaced with a conventional cursor image. This later feature provides the user with the option of discontinuing display of the cursor-based advertisement. Alternatively, the cursor based content can also be set to deploy if a user makes certain actions, such as movement towards a back button or towards a certain location on a page.

The selection of a particular cursor-based advertisement to be displayed to the user can be based on various targeting criteria. For example, known contextual analysis techniques can be used to evaluate the subject matter of the page being viewed to determine relevant advertising content to be provided to the publisher server 115. The content being evaluated can include other advertisements that are presented on the page provided by third-party suppliers, in which case a suitable ad, either complementing or competing with the third-party advertisement, can be selected to be displayed. In addition, advertising content can be selected for delivery based on cookies, user registration information or other historical or demographic data available about the user. Further, the advertising content can be selected based upon a contextual analysis of the underlying content being viewed by the user such that a delivered cursor-based advertisement would be relevant to the underlying content. In this regard, a linguistic analysis program as known in the art can operate at the publisher server 115 or client computer 120. The linguistic analysis program evaluates the content provided to the client computer and may derive one or more keywords that are relevant to the underlying content an provide these keywords to the advertising server 110 which then identifies and delivers an appropriate advertisement to the client computer 120 either directly or via the publisher server 115. Linguistic analysis programs use various techniques to determine relevance, from simple word identification to complex analysis of the relationship of nouns, verbs, primacy, frequency and the like. The particular linguistic analysis tool used is not critical to the practice of the present system and method so long as some measure of relevance of the content to an advertisement is achieved.

The advertising content can also be selected or altered based on the time of day and/or the location of the user, if known. Other known techniques for determining advertising relevance or targeting can also be applied.

Unlike a traditional cursor graphic, which is typically limited to a 32.times.32 pixel display area, the present system provides for a more general display space to be defined and associated with the cursor or touchpoint location. For example, a generalized text or graphics display space can be coupled to the standard 32.times.32 pixel cursor display area and move in conjunction with this cursor display area as a modified cursor image. In this way, higher resolution graphics and more detailed textual information can be conveyed through the use of the modified cursor image. Preferably, when the user of the client computer addresses the publisher website, the content for the website is provided to the client computer, generally in the form of HTML, XML or other graphics/scripting based language or other suitable advertising programming code.

In the present system, the instructions that will be used by the client computer 120 to alter the cursor image from a standard image, such as an arrow, to an advertising specific image, such as the image of the spokesman for the sports drink being advertised, may be provided by the publisher website as a component of the website content code or as pass-through code supplied by the cursor advertising supplier. This allows the client computer to receive and respond to the cursor instructions without requiring the client to have previously received and installed software, such as an applet or browser plug-in, that would remain resident on the client computer or mobile device. For example, an instruction code such as <script src=“http://beta.f.adbull.com/79.sub.--33.js”></script> can be imbedded in or delivered with the advertising content. This instruction identifies the location, such as on advertising server 110 can be invoked and operated by the client computer 120. An example of the invoked code listing is set forth in Appendix 1, appended hereto. This implementation may alleviate concerns that arose with previous advertising delivery systems that the advertising delivery system was loading “spyware” or “mal-ware” onto a client computer 120.

In other embodiments, the advertising code may be integrated into an RSS feed, or any suitable Java script, XML or similar supported environment that is know in various communication interfaces, such as web browsers and custom applications such as Twitter™ for easy distribution to the client computer or mobile device.

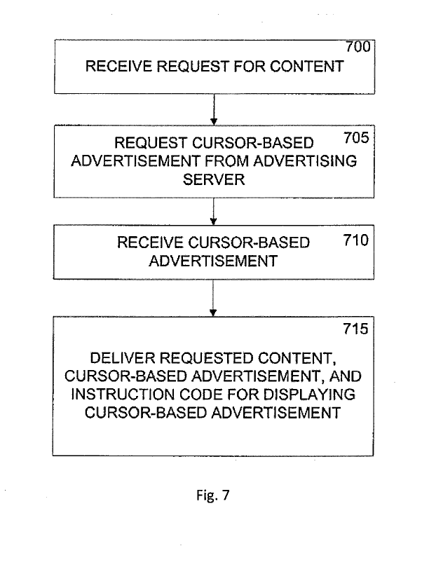

An overview of the general operation of the publishing server 110 is provided in the flow diagram of FIG. 7. When a user of a client computer 120 requests content, that request is received at publisher server 115 in block 700. The publishing server responds to the request by requesting appropriate cursor-based content from the advertising server in block 705. A number of different methods may be used by the publishing server to request relevant cursor-based content, such as by the general subject matter of the publisher website, demographic data of the user, contextual/linguistic analysis of the requested content and the like. The publisher server receives cursor based content, such as from the advertising server 110 (block 710). The publisher server 110 may also receive, along with the cursor-based content, instruction code to be provided to the client computer to enable display and tracking of the cursor based content on the client computer 120. The publisher server 115 then delivers the requested content, the cursor-based content and the instruction code for displaying the cursor based content, to the client computer 120 (block 715).

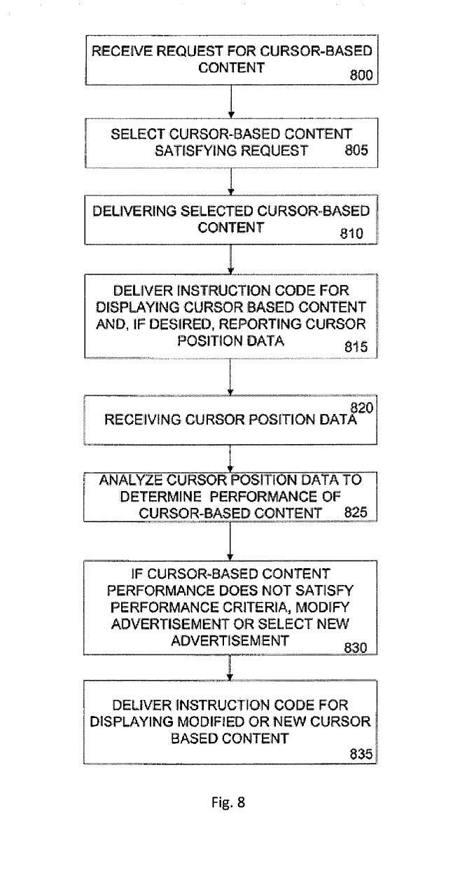

A simplified overview of the operation of the advertising server is provided in the flow diagram of FIG. 8. A request for cursor-based content is received, such as from a publisher server 110 (block 800). The advertising server than selects appropriate cursor-based content in response to the request (block 805) and delivers the selected cursor-based content, or information such as a link to the content, to the publisher server (block 810). The advertising server 110 may also provide instruction code that enables the client computer to display the cursor based content. The instruction code may also provide code for tracking and reporting a users cursor position and other cursor related metrics (block 815). In the event that it was desired to receive and record cursor metrics, such as cursor position and time data, the advertising server may receive such data from the client computers or indirectly via the publisher server 115 (block 820). The received data, which may include but does not require personal identification information, is provided to the cursor metrics analytics engine 145 which may evaluate cursor metrics, such as cursor position versus time, cursor velocity, and the like to determine whether a particular advertisement is meeting performance targets (block 825). If it is determined that the advertisement's performance does not satisfy the performance criteria, the cursor based content can be modified in some way to attract user attention or new cursor-based content may be selected (block 830). The new or modified cursor based content can then be delivered to the publisher server 115.

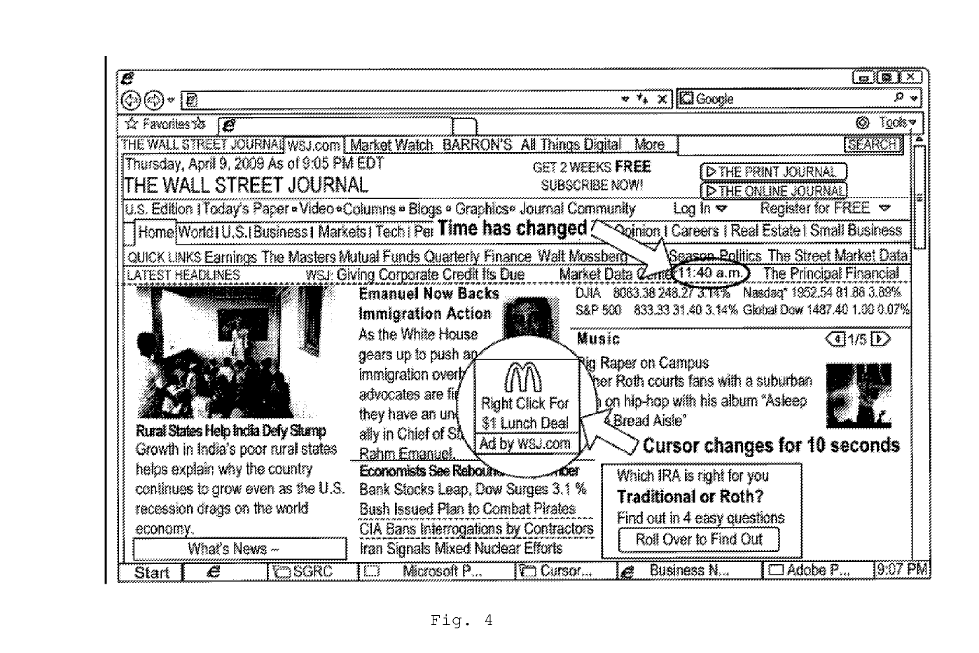

FIGS. 3-5 illustrate another example of the current cursor-based advertising system. These figures illustrate a typical progression of a cursor-based advertising sequence which includes time-based and action-based triggers for the advertising content. In FIG. 3, a client is reviewing content on a news based publisher website. When the user first enters the publisher website, no cursor-based advertisement is selected for delivery. As noted by the clock illustrated in FIG. 3, the time is 11:39 am in this first example.

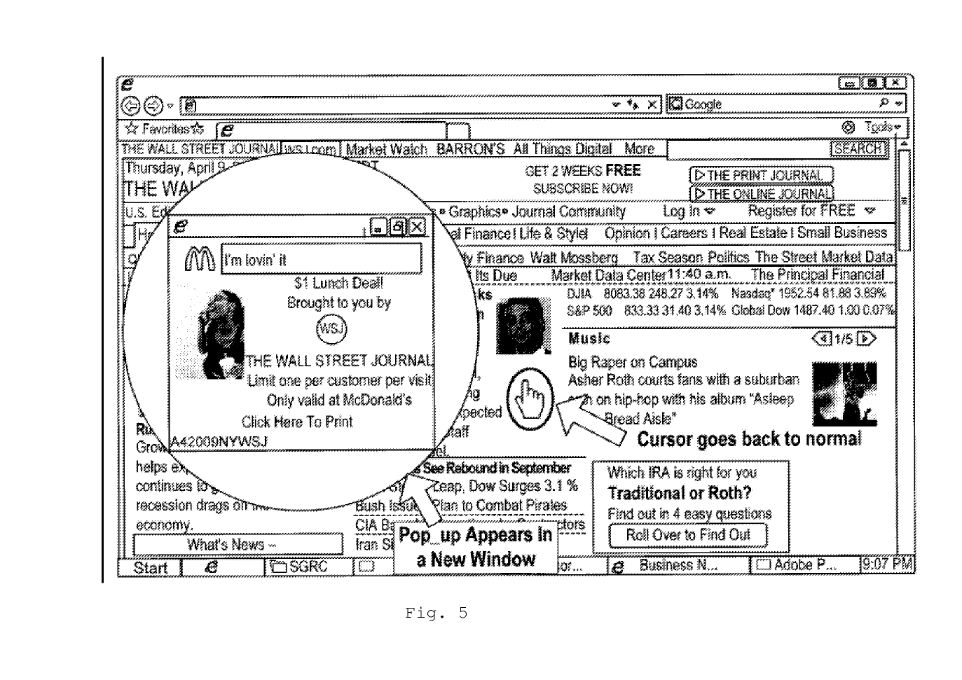

In the example illustrated in FIG. 4, the time has advanced to 11:40 am. In this example, a food vendor has created an advertising campaign that targets viewers of the publisher website at a certain time, such as between 11:40 am and 12:40 pm, for delivery of advertising content related to its restaurant. Thus, at 11:40, the cursor displayed on the client computer 120 changes from a standard cursor image, such as the hand displayed in FIG. 3, to the logo and message provided in FIG. 4. The cursor-based advertisement of FIG. 4 further includes the invitation to “right click for $1 lunch deal,” prompting the user to take further action and thereby receive a coupon or further promotional material, such as illustrated in FIG. 5. The cursor can continue to display the cursor-advertisement for a predetermined amount of time, until some activity at the client computer 120 is detected, or some combination of time and activity. For example, the advertisement can be displayed continuously so long as no cursor motion is detected and then change back to the standard cursor image following a predetermined time after some cursor movement is detected. This will provide an opportunity for the advertisement to be seen by the user even if they are away from the computer momentarily when the advertisement is first displayed, yet also revert to the standard image in a timely fashion to minimize user annoyance.

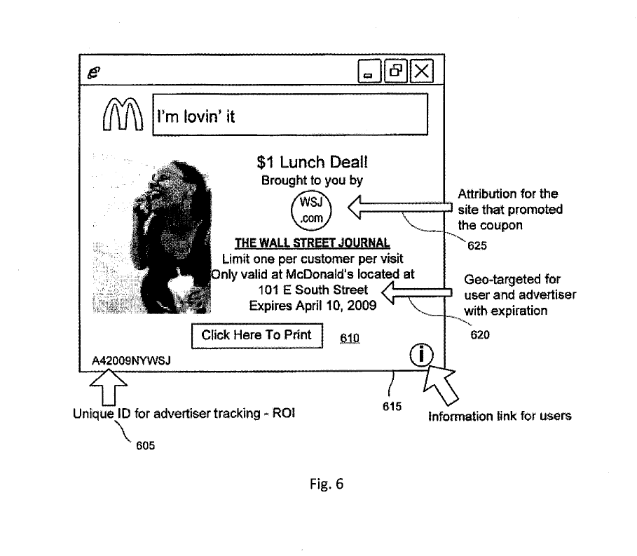

As illustrated in FIG. 6, the coupon or promotional material provided to the user after an invited action associated with the cursor-based advertisement can include a number of features. For example, the promotional material can include a unique identifier that facilitates advertiser tracking of the promotion. This is helpful to the advertiser to determine the effectiveness of the promotion and to calculate return on investment (ROI) for the promotion. The promotion can also include an action button to print a redeemable coupon. The promotion can also include an information link 615 that can, for example, include a description of the advertising service delivering the cursor based advertisement. In certain instances, the approximate geographic location of the user can be determined based on user demographics or more precisely determined if the client computer has a positioning system, such as Global Positioning System (“GPS”) capability. When geo-tracking techniques are used, or the user's location is otherwise known, the promotion can be geo-targeted, such as by specifying a specific address or region where the coupon may be redeemed. For example, as illustrated in FIG. 6, the promotional material can be generic to a brand, or can be specifically targeted to a particular address when geo-targeting establishes that the user is close to a particular location for that brand, such as “101 E. South Street.”

The current system also contemplates the use of cursor position and motion to determine, at least in part, user behavior and advertisement responsiveness. Based on a study comparing eye-tracking and mouse pointer behavior, it has been shown that over 80% of the time a user moves their mouse cursor to an area of their screen, that same area was also looked at by the user. Similarly, this study demonstrated that approximately 88% of the time, regions that were not subject to eye-gaze were also not visited by the mouse cursor. Thus, there is believed to be a strong correlation between cursor location and eye-gaze.

Recognizing this phenomenon, it is believed that cursor position may be used as a reasonable proxy for determining where on a display a user's attention is drawn. By providing feedback from the client computer 120 on cursor position in connection with advertising variables, such as time, display advertising content, cursor-based advertisement content and the like, the effectiveness of various advertising vehicles in capturing the attention of a user can be measured using the current system. In this regard, the software embedded in the delivered advertisement may include instructions that allow the tracking and reporting of cursor position, such as to the advertising server 110. Alternatively, other servers, not shown, may receive and process the cursor data. This client computer may provide data regarding cursor coordinates, time stamps, and the like, which are readily accessible parameters on a typical graphical user interface in a client computer or mobile device. This information can be sent to a cursor metrics analytics engine 145 residing in the advertising server 110, or other computer server, without requiring personal identifying information (PII) and still provide useful feedback regarding the performance of the advertisement. If the client has authorized the release of PII, this information can be incorporated into that clients user profile to improve the delivery of future advertisements and services. This can be beneficial in CPM based display advertising, where an advertisement may be effective at enhancing brand reputation by being viewed even if there is no immediately measurable performance-based metric, such as a click-through, associated with the display of that advertisement.

In addition to cursor position, cursor movement in response to various events and relative dwell time of the cursor in certain locations on the display can also provide meaningful data regarding the effectiveness of an advertisement. For example, the direction of cursor movement towards or away from an advertisement being displayed may be an indication of relative interest in the advertising content. Further, the location within the advertising content that a cursor visits may also be indicative of which portion of the advertising content is most significant to the user. Thus, the advertising code provided with the cursor-based advertisement preferably includes code for determining cursor position and reporting the cursor position, and other desirable metrics, back to the advertising server. Cursor position can be used for post-display analytics as well as for dynamically controlling the advertising content to promote a further response. For example, if a particular cursor-based advertising image does not result in a desired cursor action, the content can be altered to capture the viewers attention and promote further action. The cursor position data can also be presented to advertisers in various form on an advertiser interface 140. For example, “heat maps” illustrating a color coded depiction of frequency of cursor position may be presented to visualize the regions of the display most frequented by the cursor. Other forms of data presentation, such as graphs and topographical charts, illustrating various cursor metrics can also be used to assist an advertiser in evaluating the effectiveness of particular advertising. Each of these functions may be performed in the cursor metrics analytics engine 145.

The use of dynamic changes in advertising content can alter the cursor-based advertisement, a display advertisement or both. As an example, referring to FIG. 2, if after 20 seconds of displaying the advertisement for the sports drink, no favorable cursor activity was detected (e.g., cursor movement over or towards the advertisement) a new cursor based image could be presented that more actively directs the users attention to the display ad. This can be by way of a graphic that directs the users attention towards the display add (such as by changing the image of the spokesman on the cursor-based advertisement to point towards the display advertisement) or by a simple text message, such as “see our ad on this page.”

It is known that a touch screen may be used to implement a GUI in a computing device. Indeed, such interfaces have grown in popularity, particularly in mobile devices, such as cellular phones, music players and tablet computers. With a touch screen interface, a cursor may not need to be displayed since the user can select any spot on the interface as a touchpoint. In such an embodiment, the present cursor based systems and methods can still be applied. In a touch screen device, the touchpoint is used as the location of the cursor-based advertisement. In a similar manner to that described above, various touchpoint based advertising can be delivered. Similar to cursor position, data regarding the location of touchpoints over time can be monitored and reported by the client computer. In a similar manner as described above with respect to cursor position, touchpoint position can also be used in performing the analytic methods described above.

The advertising server 110 may also include an accounting module 150 (in FIG. 1) to track advertising delivery and performance metrics and to assist in billing and revenue distribution functions. As is known in the art of network based advertising delivery, there are a number of revenue models that can be applied to advertising delivery. For example, an advertiser may pay to have an advertisement delivered to a certain number of users using a so-called CPM, or cost per thousand page view model. In this case, the advertising server would account for the number of times the advertisement was served and would base the advertising delivery charge on this number. Various performance based models, such as pay-per-click, pay for purchase and the like are also known. In such models the advertising server will track not only the number of times that an advertisement was delivered, but would also track the relevant performance based metric. The advertising server may also track the particular publisher server that requested and delivered the advertisement to provide an account record for any applicable revenue sharing relationship that may be in place between the operator of the advertising server 110 and the publisher server 115. The specific implementation of the accounting module is not critical to the practice of the present systems and methods and those skilled in the art understand how to implement appropriate accounting modules for the various billing and revenue models.

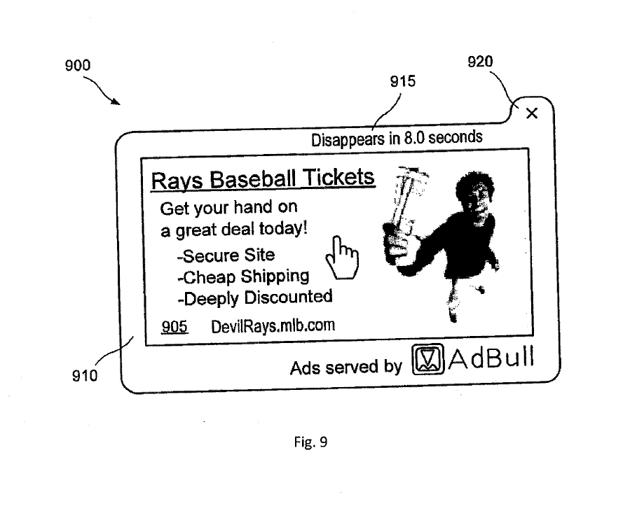

Another aspect of the present systems and methods is the use of a “container” for delivering cursor based. Referring to FIG. 9, the container 900 can accept either standard IAB dimensioned or non-IAB standard advertising units 905, within the container frame 910. In addition, the container 900 allows an advertiser, via the advertiser interface 140, to configure various features and options associated with the presentation of the cursor-based content. For example, the container may be configured to only display for a certain amount of time, which can be graphically displayed with the container either by a countdown timer or graphical indication of the remaining time, such as an hour glass or other time-based symbol. The container definition can also include a specification that allows the cursor-based content to separate itself from the cursor after a predetermined action or period of time. As an example, after a predetermined time or a user clicking the X symbol 915 on the container, the cursor based content can detach from the current cursor position and move to a position on the display specified in the container parameters, such as top left, top right, bottom left, bottom right, or any particular X-Y coordinate specified by the advertiser and embedded in the container specification.

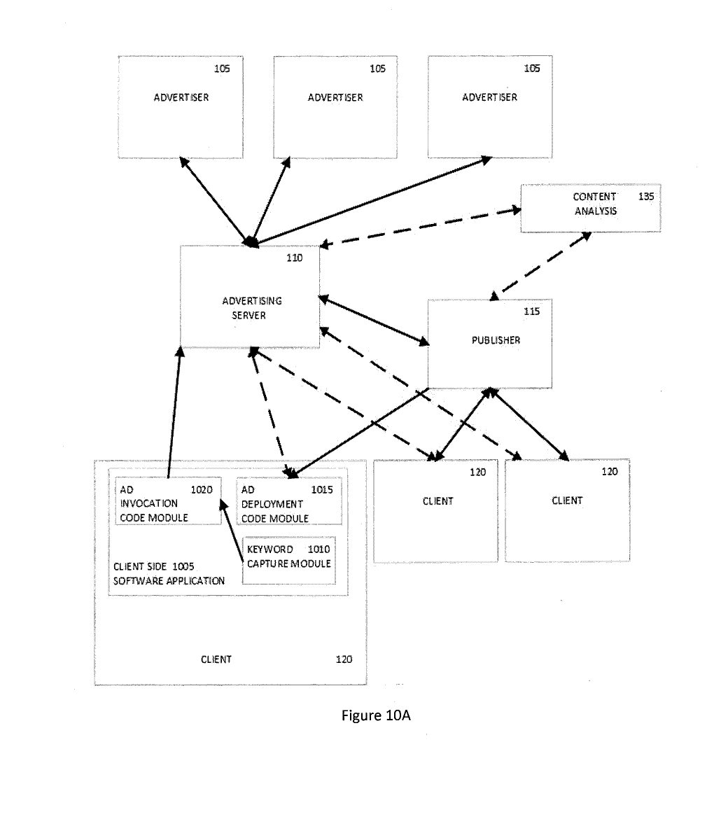

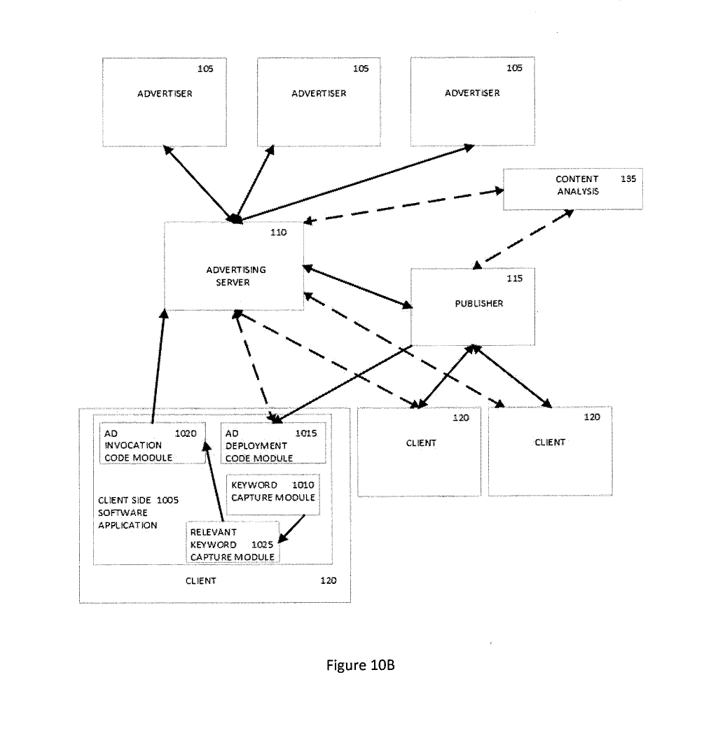

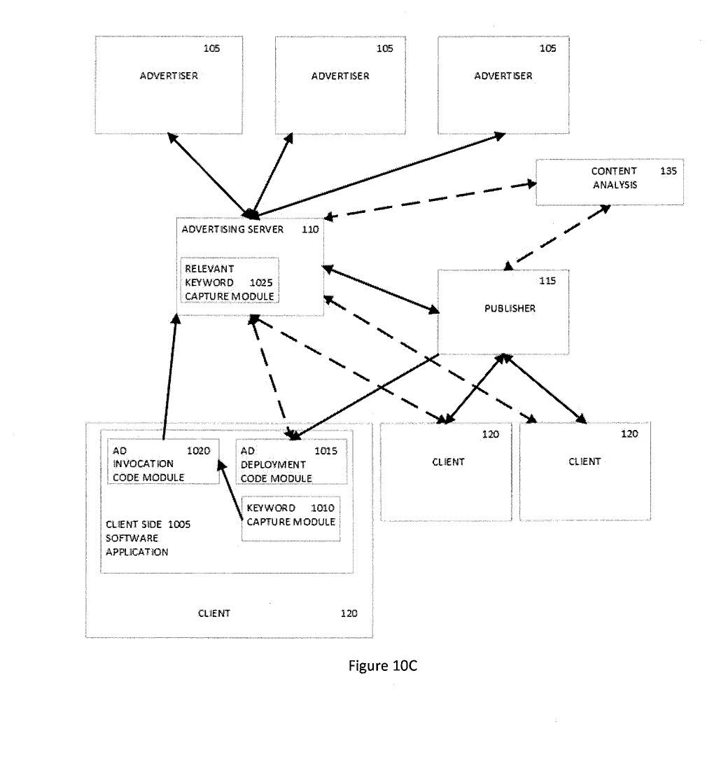

FIG. 10A is a block diagram illustrating the interaction among the advertising server 105, publisher server 115, content analysis 135, and a client side software application 1005 installed on a client computer 120. The present system includes a client side software application 1005 for analyzing user input. The client side software includes a keyword capture module 1010 to fetch the keywords or webpage URLs inputted by a user input. The user input may be in the form of a user requested content or any search string entered in a toolbar, a browser plug-in, a search bar in a webpage or an address bar in a browser etc. The client side software application 1005 is implemented in the form of a web plug-in, a browser plug-in, a browser toolbar, a browser address bar, a downloadable software etc. The client side software application 1005 also includes an ad deployment code module 1015 and an ad invocation code module 1020. The ad invocation code module 1020 is responsible for placing an ad call to the advertising server 105 to retrieve advertisement. The ad invocation code module 1020 places an ad call after a user requests for a web page or enters a search string or key word in the browser tool bar. Based on the ad call the advertising server 105 transmits an appropriate advertisement to the ad deployment code module 1015. The ad deployment code module 1015 then displays the appropriate advertisement on the landing page. The advertisement transmitted by the advertising server can be in any format which includes but not limited to banner advertisement, cursor advertisement, pop-up advertisement etc.

In one of the embodiments, an advertiser has to register and create an account with the advertising sever 110. During registration, the advertiser has to input some information via the advertiser interface 140. The information includes personal information, type of advertisements, relevant URLs/keywords to be considered during retrieval of the advertisement, time duration of display, bidding rate, advertising content etc. The information entered by the advertiser is not critical to the practice of the present system and method so long as the system provides an advertiser interface 140 to register with the advertising server 110.

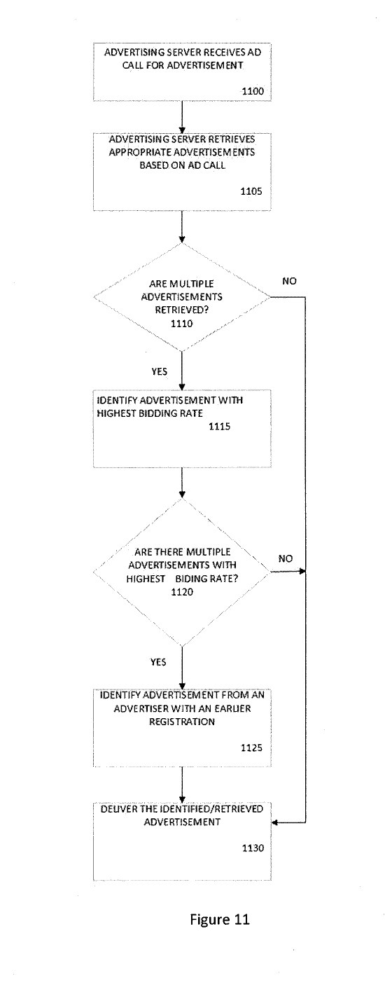

When a user searches for a specific content on a browser, a website or a toolbar by entering specific keywords or search-string, the keyword capture module 1010 fetches keywords from the user input. The keyword capture module 1010 transmits these keywords to a relevant keyword capture module 1025 as shown in FIG. 11B. The relevant keyword capture module 1025 uses various techniques to determine relevance, from simple word identification to complex analysis of the relationship of nouns, verbs, primacy, frequency and the like. Based on the analysis, the relevant keyword capture module 1025 identifies the relevant keywords and transmits the relevant keywords to the ad invocation code module 1020. The ad invocation code module 1020 then places an ad call to the advertising server 110. The ad call including the relevant keywords is then received at the advertising server 110 as a database query. The advertising server 110 stores a database of advertisements corresponding to a set of keywords as specified by advertisers. The advertising server 110 uses the database query to retrieve the appropriate advertisement corresponding to the keywords. The appropriate advertisement is then delivered to the client computer 120 directly or via the publisher server 115. The ad deployment code module 1015 then displays the advertisement in the form of banner advertisement, cursor advertisement, pop-up advertisement etc. The various specific modes of advertisement-display are not critical to the practice of the present system and method so long as the system displays the advertisement.

In another embodiment the relevant keyword capture module 1025 can be implemented on an advertising server, as shown in FIG. 11C. In this embodiment, the keyword capture module 1010 fetches keywords from the user inputs such as search for a specific content on a browser, a website or a toolbar by entering specific keywords or search-string. The keyword capture module 1010 transmits these keywords to the ad invocation code module 1020. The ad invocation code module 1020 then places an ad call to the advertising server 110. The ad call including the keywords is then received at the advertising server 110. The relevant keyword capture module 1025 analyses the keywords using various techniques to determine relevance, from simple word identification to complex analysis of the relationship of nouns, verbs, primacy, frequency and the like. Based on the analysis, the relevant keyword capture module 1025 identifies the relevant keywords and generates a database query for the advertising server. The advertising server 110 uses the database query to retrieve the appropriate advertisement corresponding to the keywords. The appropriate advertisement is then delivered to the client computer 120 directly or via the publisher server 115. The ad deployment code module 1015 then displays the advertisement in the form of banner advertisement, cursor advertisement, pop-up advertisement etc. The various specific modes of advertisement-display are not critical to the practice of the present system and method so long as the system displays the advertisement.

In another embodiment when a user requests for a specific website by entering a URL in a browser, the keyword capture module 1010 fetches the URL. The keyword capture module 1010 transmits the URL to the ad invocation code module 1020. The ad invocation code module 1020 then places an ad call to the advertising server 110. The ad call including the URL entered by the user is then received at the advertising server 110 as a database query. The advertising server 110 stores a database of retargeted advertisements corresponding to specific URLs as specified by advertisers. The advertising server 110 uses the database query to retrieve the appropriate retargeted advertisement corresponding to the URL. The appropriate retargeted advertisement is then delivered to the client computer 120 directly or via the publisher server 115. As known in the art, after a user has shown some interest for a specific website, a retargeted advertisement relevant to the specific website is delivered to the user when the user visits some other website. The delivered appropriate retargeted advertisement is received by the ad deployment code module 1015. The ad deployment code module 1015 then displays the retargeted advertisement, when a user visits some other websites. The deployment of the retargeted advertisement may be in the next website that the user visits or in any other subsequent websites the user visits.

In one of the embodiments, the advertising server 110 may retrieve multiple advertisements corresponding to a specific keyword or a specific URL, as shown in FIG. 11. As for example, the advertising server may receive the ad call with keyword ‘mobile’ (block 1100). An advertiser A and an advertiser B may have specified the keyword ‘mobile’ as relevant to their advertisement while registering for the account with the advertising server 110. In this case the advertising server 110 retrieves both the advertisement (block 1105). The advertising server 110 then identifies the advertisement which has the highest bidding rate, as specified by the corresponding advertisers during the registration with advertising server 110 (block 1115). The identified advertisement with highest bidding rate is then delivered to the client computer 120 (block 1130). However, there may be a scenario in which the advertising server 110 identifies two advertisements from two different advertisers with a same bidding rate (block 1120). As for example advertisements from both the advertiser A and the advertiser B have a bidding rate of $150. In this case the advertising server 110 will check which one of the advertiser A and advertiser B has registered earlier with the advertising server 110 (block 1125). The advertisement from the Advertiser with earlier registration will be delivered to the client computer 120 (block 1130). Another option would be to display the advertiser that is located closest to the user based upon IP mapping and geo-targeting.

In another embodiment, the existing cursor image is modified such that a cursor advertisement is displayed as a satellite image along with the cursor image as soon as the user-requested web page is loaded. The cursor advertisement is placed within the container 900. In this case, the deployment of cursor advertisement occurs without the need for the user to click on the webpage, which is loaded as a result of the user's request for the web page. The instruction code sent from the publisher server 115 includes a trigger script. When the trigger script detects that the loading of web page is complete, it causes cursor modification even before the user clicks on the web page. The trigger script initiates the modification based on various trigger events such as a lapse of predetermined amount of time, a detection of movement of cursor after the loading of the webpage is complete etc.

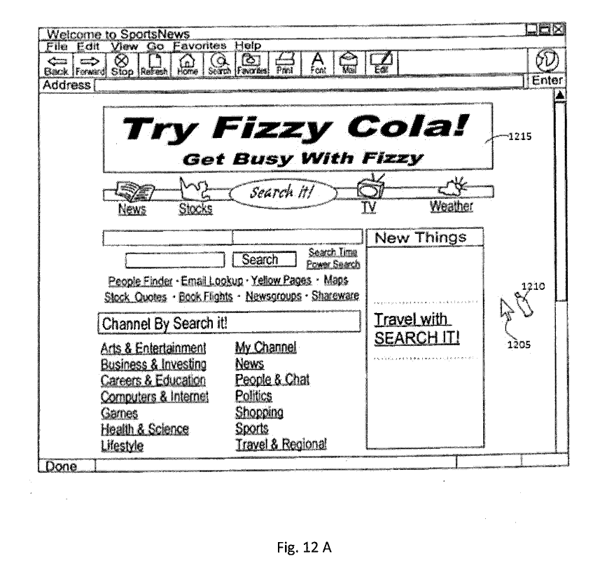

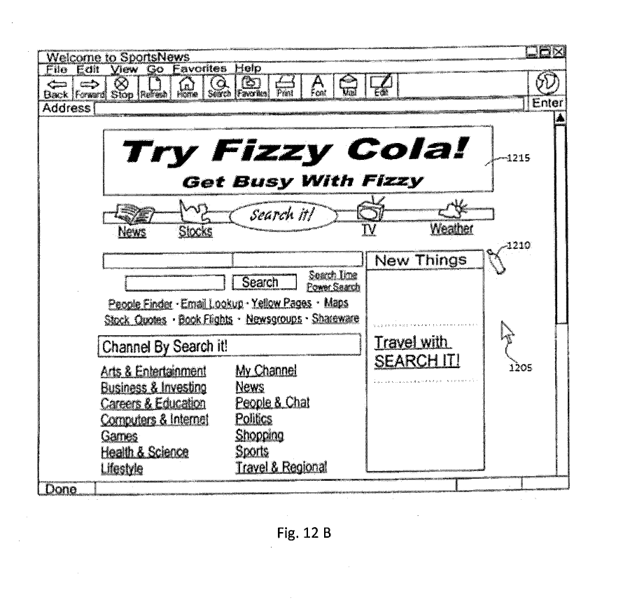

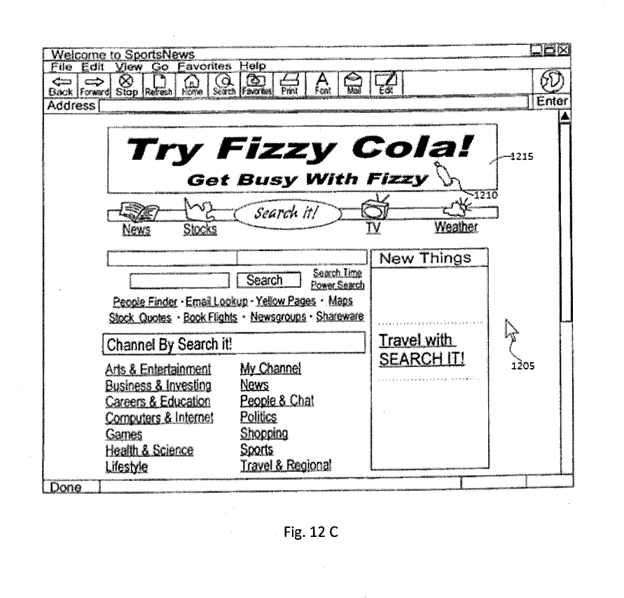

In another embodiment of the invention, the publisher server 115 sends the banner advertisement as well as the instruction code along with the content requested by the user. The instruction code contains a trigger script to cause the cursor advertisements to be displayed along with the banner advertisements. The cursor advertisements are displayed by cursor modification. Displaying a banner advertisement along with corresponding cursor advertisement increases the chances of getting the user's attention than just displaying the banner advertisement. Here, the banner advertisement is used as an example. However, it may be understood that any other type of advertisement such as video advertisement, anchor advertisement, pop-up advertisement, pop-under advertisement etc may also be used in place of banner advertisement throughout this invention. As illustrated in FIG. 12A, when a banner advertisement for Fizzy cola 1215 is displayed, the cursor image 1205 may be modified to represent a Fizzy cola bottle 1210 or Fizzy Cola's logo, its corporate mascot, images of its products or services, slogans, icons, brand images, advertising messages (the word “Thirsty?”, for example), abstract suggestions (such as a straw or glass), etc.

In one of the embodiments, a website host uses its own proprietary advertising server other than advertising server 110 for displaying banner advertisements along with requested web pages. In this scenario only the webpage and the banner advertisement are sent to the user from the publisher server 115. No instruction code is sent from the publisher server 115 to the user as there is no display of cursor advertisement along with the banner advertisement. However, if the website host wishes to display a cursor advertisement along with the banner advertisement while using its own proprietary advertising server, the instruction code including the trigger script for the cursor advertisement display needs to be embedded in the banner advertisement. The trigger script, being a part of the instruction code sent from the publisher server 115, is executed at the client computer 120 to display the cursor advertisement along with the banner advertisement.

In another embodiment, the cursor advertisement displayed simultaneously with the banner advertisement may get detached from the cursor image based on the trigger script when the trigger event takes place. The cursor advertisement then moves towards the banner advertisement as shown in FIG. 12B and FIG. 12C. This causes the user's attention to move from the cursor on to the banner advertisement. Referring to the Fizzy Cola example discussed previously, the fizzy cola bottle 1210 that appears as part of the cursor 1205 after cursor modification (as shown in FIG. 12A) is detached from the cursor 1205 (as shown in FIG. 12B) after a lapse of time and moves towards the Fizzy cola banner advertisement 1215 (as illustrated in FIG. 12C). The fizzy cola bottle 1210 hovers over the Fizzy cola banner advertisement 1215 for a predetermined amount of time. The fizzy cola bottle 1210 disappears after the predetermined amount of time elapses.

The trigger script of the instruction code may set up different trigger events to initiate the flyback of the cursor advertisement to the banner advertisement. A timer in the trigger script would start as soon as the cursor advertisement is displayed. When the predetermined amount of time elapses, the cursor advertisement is forced to fly back to the banner advertisement. Another trigger event that can be used is detection of cursor activity after a predetermined amount of cursor inactivity. This could imply that the user's attention is back to the display after a period of inactivity. Hence the movement of the cursor advertisement back to the banner advertisement at that instance could get maximum attention of the user. As discussed previously, clicking on the cross close button by the user can also act as a trigger event to cause the cursor advertisement to detach from the cursor and move back to the banner advertisement. The above mentioned examples of trigger events are only some of the ways to cause the detachment of the cursor advertisement from the cursor. There can be many other forms of trigger events for the detachment of cursor advertisement as would be known to persons skilled in the art.

The foregoing discussion describes some example embodiments to perform cursor-based content delivery. Although the foregoing discussion has presented specific embodiments, persons skilled in the art will recognize that changes may be made in form and detail without departing from the spirit and scope of the embodiments.

1. A client side computer system for receiving advertising content in a computer network comprising:
a user input device;
a display device;
a keyword capture module extracting keyword data from user input;
an ad invocation module responsive to the keyword capture module and generating an advertising call request to an advertising server; and
an ad deployment module receiving an advertisement from the advertising server and displaying the advertisement on a requested webpage on the display device.

2. The client side computer system of claim 1, wherein the keyword capture module, ad deployment module, and ad invocation module are implemented as programming instructions operating on a general purpose computer processor.

3. The client side computer system of claim 2, wherein the programming instructions take the form of one of a web plug-in, a browser plug-in, a browser toolbar, or a browser address bar.

4. The client side computer system of claim 1, wherein the advertisements are selected from the group including banner advertisements, cursor advertisements, or pop-up advertisements.

5. The client side computer system of claim 4, wherein the advertisements include a banner advertisement and a cursor advertisement, the banner advertisement and cursor advertisement having related content.

6. A method of displaying advertising content on a computer system comprising:
displaying first advertising content on a display device at a first location;
displaying second advertising content on a display device in a second location, said second location being determined at least in part by a location of a cursor,
moving the second advertising content from a location determined at least in part by a location of a cursor to said first location, such that the second advertising content is proximate the first advertising content.

7. The method of claim 6, wherein the second advertising content being related to the first advertising content.

8. The method of claim 7, wherein the second advertising content is an image related to the first advertising content.
